(19) United States
(12) Patent Application Publication
(10) Pub. No.: US 2012/0180134 A1
(43) Pub. Date: Jul. 12, 2012

(54) Personal Information Guard

(75) Inventors: Christopher Glenn Coughtrey, Ottawa (CA); David Noel Vanden Heuvel, Ottawa (CA); Oscar Echeverri, Ottawa (CA)

(73) Assignee: RESEARCH IN MOTION LIMITED, Waterloo (CA)

(21) Appl. No.: 12/986,795

(22) Filed: Jan. 7, 2011

(51) Int. Cl. G06F 21/24

(52) U.S. Cl. 726/26

(57) ABSTRACT

A user equipment (UE) having a processor configured to scan a message content for personal information and indicate any detected personal information before sending the message from the UE. Also disclosed is a method implemented on a UE comprising scanning a message content for personal information, and indicating any detected personal information before sending the message from the UE.

### BACKGROUND

As used herein, the terms “user equipment” and “UE” might in some cases refer to mobile devices such as mobile telephones, mobile devices, personal digital assistants, handheld or laptop computers, and similar devices that have telecommunications capabilities. Such a UE might consist of a UE and its associated removable memory module, such as but not limited to a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UE might consist of the device itself without such a module. In other cases, the term “UE” might refer to devices that have similar capabilities but that are not transportable, such as desktop computers, set-top boxes, or network appliances. The term “UE” can also refer to any hardware or software component that can terminate a communications session for a user. Also, the terms “user equipment,” “UE,” “user agent,” “UA,” “user device” and “user node” might be used synonymously herein.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a communications system that allows a UE to communicate with other network components and/or devices according to an embodiment of the disclosure.

FIG. 2 is a flowchart of a method for scanning a message content on a UE for personal information before sending the message according to an embodiment of the disclosure.

FIG. 3 is a flowchart of another method for scanning a message content on a UE for personal information before sending the message according to an embodiment of the disclosure.

FIG. 4 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with the full scope of equivalents.

A UE, for example a mobile device, may be used to send text or content in a message, such as using email, Short Message Service (SMS), Twitter application, or any other messaging/chatting service. In some cases, the message content or text may include personal information that may be inadvertently entered by a user of the UE. As such, the user may send the message without being aware of the personal information in the message content. The personal information may be private information, such as the user's phone number, physical or mailing address, email address, credit card number, or other personal information, which may not be intended for sharing or may cause harm to the user if used inappropriately by a non-intended recipient of the message. Therefore, the user's privacy may be protected if the user is alerted to the personal information in the message content before transmitting the message.

Disclosed herein is a system and method for scanning the message content to detect any personal information in the message and alert the user to any detected personal information before transmitting the message. In one embodiment, the message content may be scanned to detect any personal information using pattern/character recognition. In another embodiment, the message content may be scanned and compared to a list of personal information to detect any match. The user may be prompted to the existence of personal information in the message before beginning transmission and hence may decide to abort or proceed with transmission. The user may also choose to delete or remove the personal information and then proceed with transmission.

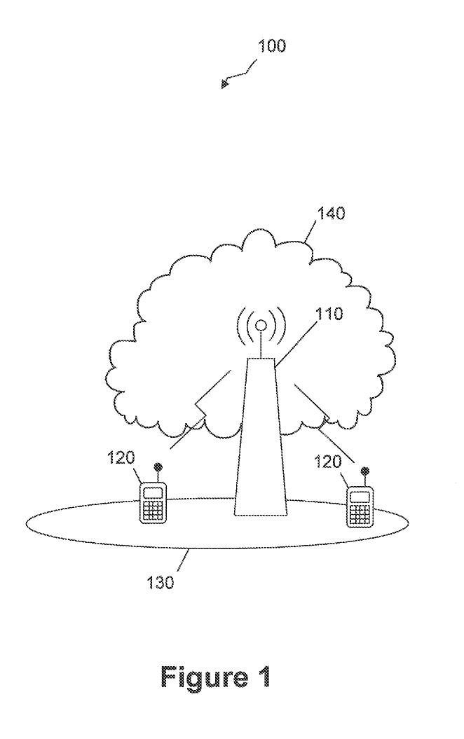

FIG. 1 illustrates an embodiment of a radio access network (RAN) 100, which may be a long-term evolution (LTE) or LTE-Advanced (LTE-A), as described in the Third Generation Partnership Project (3GPP), or other well known or after developed networks. In this example, an LTE or LTE-A system might include an Evolved Universal Terrestrial Radio Access Network (E-UTRAN) node B (or eNB), a wireless access point, or a similar component rather than a traditional base station. FIG. 1 is exemplary and may have other components or arrangements in other embodiments. In an embodiment, the RAN 100 may comprise at least one access device 110 and at least one UE 120, which may be both located within a cell 130.

As used herein, the term “access device” refers to any component of the wireless network, such as a traditional base station, a wireless access point, or an LTE or LTE-A node B or eNB, that creates a geographical area of reception and transmission coverage allowing a UE 120 or a relay node (not shown) to access or communicate with other components in a telecommunications system, such as second UE 120. In this document, the term “access node” and “access device” may be used interchangeably, but it is understood that an access node may comprise a plurality of hardware and software components.

The access device 110 may communicate with any UE 120 within the same cell 130, directly via a direct link, such as in a UTRAN. The cell 130 may be a geographical area of reception and transmission coverage. For instance, the direct link may be a point-to-point link established between the access device 110 and the UE 120 and used to transmit and receive signals between the two. Alternatively, the access devices 110 may communicate with any UE 120 in the same cell 130 over shared links, such as in an E-UTRAN. For instance, the shared links may comprise an uplink shared channel and a downlink shared channel. Additionally, the access devices 110 may communicate with other components or devices to provide for the components of the RAN 100 access to any other network 140, for instance using similar or different network protocols or technologies. In an embodiment, the UEs 120 may move about between different cells 130 and the UE's 120 communications may be handed-over between the different cells 130, where the UEs 120 may communicate with different access devices 110.

In some embodiments, the UEs 120 may communicate via a combination of wireless and wired networks. The networks may include the RAN 100, a Wireless LAN (WLAN) network, an Ethernet based network, an Internet Protocol (IP) based network, a Digital Subscriber Line (DSL) network, an Optical communications network, and/or any other wireless and wired networks that may be used to exchange communications between the UEs 120. The communications between the UEs 120 may comprise voice and/or video calls, emails, text/media messages (e.g. using SMS or Multimedia Messaging Service (MMS)), and/or any other data or message exchanges.

The UE's communications may include sending messages from the UE 120 to another UE 120 or any other recipient via the access device 110, the RAN 100, the network 140, or any other network. The message content may comprise text or media and text. For example, the UE 120 may send textual content using SMS or may send media and text using MMS. In other scenarios, the UE 120 may send textual content using email (e.g. Yahoo mail, Google mail, MSN mail, BlackBerry mail, etc.), a web-based messaging or social networking service (e.g. Twitter, Facebook, MySpace, etc.), or an Instant Messaging (IM) service (e.g. BlackBerry Messenger, Windows Live messenger, Yahoo Messenger, Google Talk, AOL Instant Messenger, ICQ, etc.).

The message content may comprise personal information that may be associated with a user of the UE 120, such as email address, birthday, credit card number, social security number, driver license, phone number, passwords, or other information that the user desires to keep private or at least limit or restrict those that have access to the information. In some embodiments, the user personal information may also include the user's full name, or the information of relatives, such as spouse or children. Such personal information may be private and may not be suitably exchanged via messaging due to security reasons. For instance, the message may be sent by mistake, for example by dialing a wrong number or entering the wrong email address, to an unintended recipient. To improve security, it may be beneficial to alert a user of the UE 120 to the existence of personal information in a message before sending the message from the UE 120. As such, the user may be made aware of the personal information in the message and hence decide to delete or allow sending this information in the message or verify that the message is addressed correctly to the intended recipient.

In an embodiment, when the user requests to send the message (e.g. click on “send” button), the UE 120 may be configured to scan the message content to detect any personal information before transmitting the message. If any personal information is detected, then the UE 120 may alert the user to the existence of personal information in the message by prompting the user for instruction such as whether to proceed with or abort transmission. In addition to the prompt, the UE 120 may display the destination or addressed recipient(s) of the message to confirm that the message is being sent to the correct party or parties. In some embodiments, the UE 120 may present the user with a plurality of choices, such as to remove the personal information from the message content and then transmit the message, abort transmission, or proceed with transmission without modifying the message content.

In another embodiment, the UE 120 may scan the message and alert the user about any detected personal information while the user is typing the message, i.e. in real-time. Thus, the user may have the chance to remove or keep the detected information while typing the message and before requesting to send the message. Further, the UE 120 may scan and detect the message using a pattern/character recognition scheme, by matching the message content to a stored list of personal information, or both, as described in detail below.

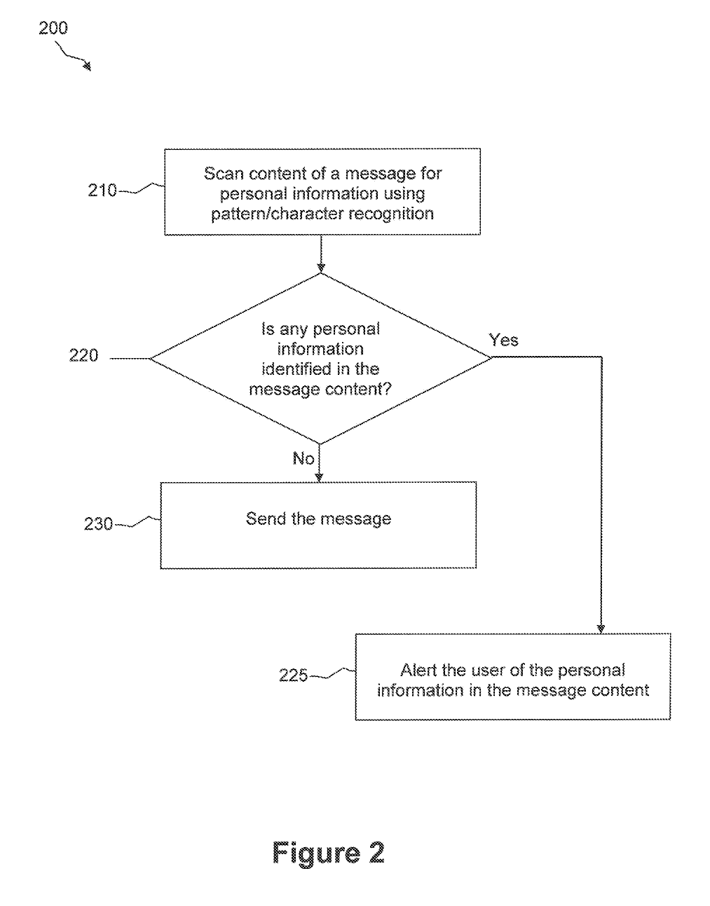

FIG. 2 illustrates an embodiment of a method 200 for scanning a message content on the UE 120 for personal information before sending the message. Specifically, the method 200 may use a pattern/character recognition scheme to detect any personal information in the message content. Accordingly, a pattern/character recognition algorithm may be used to detect or recognize patterns or characters that may correspond to personal information in the message content before transmitting the message from the UE 120. As described above, the method 200 may be implemented by the UE 120 after typing or entering the message and requesting to send the message, for example by clicking on a “send” button. Alternatively, the method 200 may be implemented in real-time while the user is typing the message.

At step 210, the UE 120 may scan the content of the message for personal information using pattern/character recognition. For instance, when the user requests to send the message, the UE 120 may parse the entire or portions of the message content and use a pattern/character recognition algorithm to detect any number sequence and/or address pattern that may correspond to personal information, such as a phone number, a social security number, a credit card number, a birthday, an address, or other personal information patterns. In some instances, the pattern recognition algorithm may also detect personal names. Further, the pattern recognition scheme may be modified by the user to detect certain user information patterns such as numbers and addresses but not personal names.

At step 220, the UE 120 may determine whether any personal information was detected in the message content. For instance, when the UE 120 parses the message content, the UE 120 may store in memory or in a file on a storage medium any detected personal information. As such, when the UE 120 is finished parsing the message content or text, the UE 120 may display any detected personal information stored in memory or file. If any personal information is detected, the method 200 may proceed to step 225. Otherwise, the UE 120 may proceed to step 230.

At step 225, the UE 120 may alert the user about the personal information in the message content. For instance, after scanning the message content and storing the detected personal information, the UE 120 may prompt the user about the personal information detected in the message. Additionally, the UE 120 may display (in the prompt to the user) the destination, such as addressed recipient(s), of the message. The prompt may also indicate the detected user information, for example by displaying a list of all or some of the detected information on the screen of the UE 120. In another embodiment, the UE 120 may highlight (on the screen) the detected personal information in the body of the message.

Additionally, the UE 120 may prompt the user for instruction about whether to continue with transmitting the message, abort transmission, or allow the user to edit or remove the message content. In some embodiments, the UE 120 may also present the user with various options for removing or deleting all the detected personal information in the message or perhaps only the personal information selected by the user. In the case the user selects to edit or delete all or selected information, the user may thereafter click on the “send” button to transmit the message.

At block 230, the UE 120 may send the message. The message may be sent after the user completes typing the message and responds to the UE prompt to allow transmission. Alternatively, in the real-time implementation, the message may be sent after the UE clicks on the “send” button.

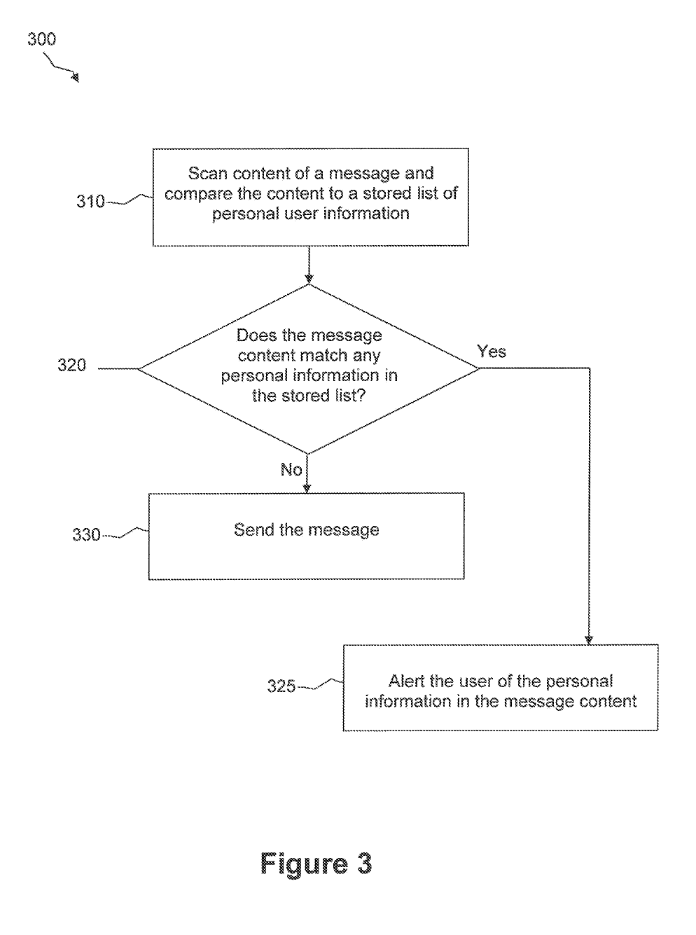

FIG. 3 illustrates an embodiment of another method 300 for scanning a message content on the UE 120 for personal information before sending the message. Specifically, the method 300 may match the message content to a stored list of personal information to detect any personal information in the message. The list of personal information may be used to filter personal information in the message content before transmitting the message from the UE 120. Similar to the method 200, the method 300 may be implemented by the UE 120 when the user requests to send the message after typing the message or in real-time while the user is typing the message.

At step 310, the UE 120 may scan the content of the message and compare the content to a stored list of personal information. For instance, when the user requests to send the message, the UE 120 may parse the entire or portions of the message content or text and compare it a predefined list of personal information. The list of personal information may be configured or edited by the user by adding specific information that the user considers private. For example, the user may add phone numbers, addresses, social security numbers, and/or any private information that the user may not wish to be inadvertently shared, or at least be alerted when the information appears in messages to be sent from the UE 120. The UE 120 determines information in the message content is personal information if the information matches any information in the predefined list of personal information. Alternatively, the UE 120 may compare the message content to the predefined list of personal information in real-time while the user is typing the message.

At step 320, the UE 120 may determine whether the message content matches any personal information in the list. For instance, when the UE 120 parses the message content, the UE 120 may store in memory or in a file on a storage medium any detected personal information. As such, when the UE 120 is finished parsing the message content or text, the UE 120 may display any detected personal information stored in memory or file. If any personal information is detected, the method 300 may proceed to step 325. Otherwise, the UE 120 may proceed to step 330.

At step 325, the UE 120 may alert the user about the personal information in the message content. For instance, after scanning the message content and storing the detected personal information, the UE 120 may prompt the user about the personal information detected in the message. Additionally, the UE 120 may display (in the prompt to the user) the destination, such as addressed recipient(s), of the message. The prompt may also indicate the detected user information, for example by displaying a list of all or some of the detected information on the screen of the UE 120. In another embodiment, the UE 120 may highlight (on the screen) the detected personal information in the body of the message.

Additionally, the UE 120 may prompt the user for instruction about whether to continue with transmitting the message, abort transmission, or allow the user to edit or remove the message content. In some embodiments, the UE 120 may also present the user with various options for removing or deleting all the detected personal information in the message or perhaps only the personal information selected by the user. In the case the user selects to edit or delete all or selected information, the user may thereafter click on the “send” button to transmit the message.

At block 330, the UE 120 may send the message. The message may be sent after the user completes typing the message and responds to the UE prompt to allow transmission. Alternatively, in the real-time implementation, the message may be sent after the UE clicks on the “send” button.

As described above, the pattern/character recognition scheme may not require predefining personal information or pre-configuring a list of personal information to detect user personal information in the message. However, using the pattern/character recognition algorithm may be slower than using a preconfigured list to detect personal information in the message content since there may be more possible positive results depending on the actual pattern recognition scheme used. The pattern/character recognition algorithm may also fail to recognize some patterns that correspond to personal information. Also, the user may become frustrated with being alerted each time the user attempts to send any phone number or email address. Alternatively, matching the message content to a predefined list of user information may result in detecting only personal information that is specified or indicated by the user but not other personal information. Thus, a combination of both methods may provide better security and protection. Therefore, in some embodiments, the UE 120 may be configured to scan the message content for personal information using both the pattern/character recognition and a predefined list of personal information. As such, the UE 120 may implement at least some of the steps in both the method 200 and the method 300 as appropriate.

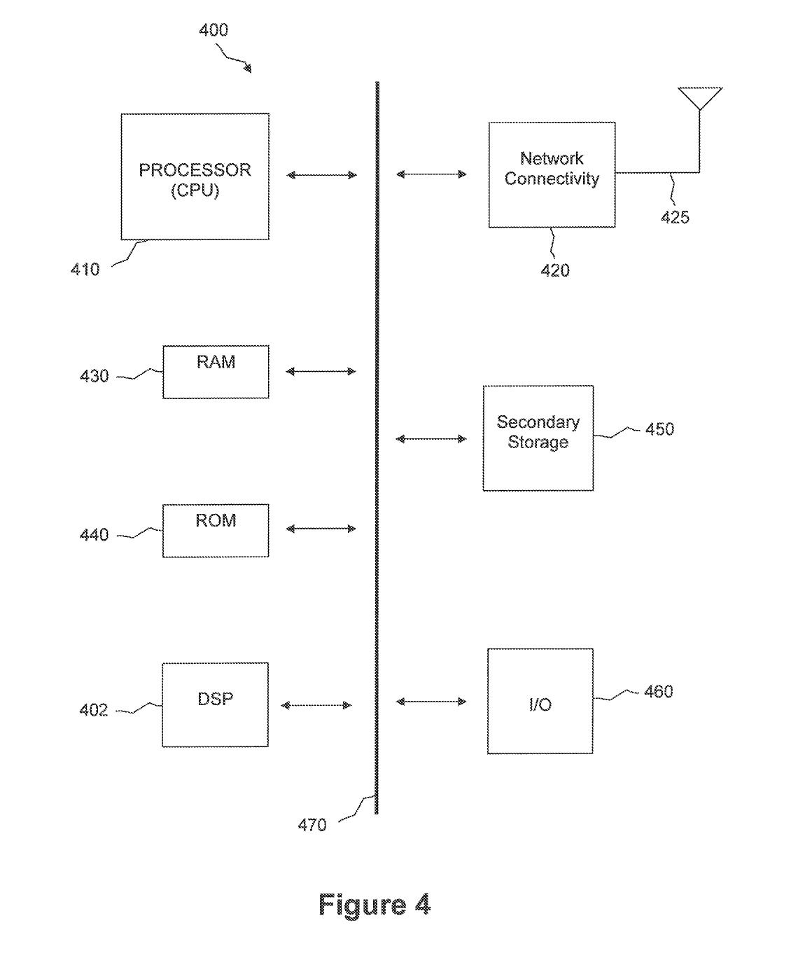

The UE 120 and other components described above might include a processing component that is capable of executing instructions related to the actions described above. FIG. 4 illustrates an example of a system 400 that includes a processing component 410 suitable for implementing one or more embodiments disclosed herein. In addition to the processor 410 (which may be referred to as a central processor unit or CPU), the system 400 might include network connectivity devices 420, random access memory (RAM) 430, read only memory (ROM) 440, secondary storage 450, and input/output (I/O) devices 460. These components might communicate with one another via a bus 470. In some cases, some of these components may not be present or may be combined in various combinations with one another or with other components not shown. These components might be located in a single physical entity or in more than one physical entity. Any actions described herein as being taken by the processor 410 might be taken by the processor 410 alone or by the processor 410 in conjunction with one or more components shown or not shown in the drawing, such as a digital signal processor (DSP) 402. Although the DSP 402 is shown as a separate component, the DSP 402 might be incorporated into the processor 410.

The processor 410 executes instructions, codes, computer programs, or scripts that it might access from the network connectivity devices 420, RAM 430, ROM 440, or secondary storage 450 (which might include various disk-based systems such as hard disk, floppy disk, or optical disk). While only one CPU 410 is shown, multiple processors may be present. Thus, while instructions may be discussed as being executed by a processor, the instructions may be executed simultaneously, serially, or otherwise by one or multiple processors. The processor 410 may be implemented as one or more CPU chips.

The network connectivity devices 420 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, GSM radio transceiver devices, worldwide interoperability for microwave access (WiMAX) devices, and/or other well-known devices for connecting to networks. These network connectivity devices 420 may enable the processor 410 to communicate with the Internet or one or more telecommunications networks or other networks from which the processor 410 might receive information or to which the processor 410 might output information. The network connectivity devices 420 might also include one or more transceiver components 425 capable of transmitting and/or receiving data wirelessly.

The RAM 430 might be used to store volatile data and perhaps to store instructions that are executed by the processor 410. The ROM 440 is a non-volatile memory device that typically has a smaller memory capacity than the memory capacity of the secondary storage 450. ROM 440 might be used to store instructions and perhaps data that are read during execution of the instructions. Access to both RAM 430 and ROM 440 is typically faster than to secondary storage 450. The secondary storage 450 is typically comprised of one or more disk drives or tape drives and might be used for non-volatile storage of data or as an over-flow data storage device if RAM 430 is not large enough to hold all working data. Secondary storage 450 may be used to store programs that are loaded into RAM 430 when such programs are selected for execution.

The I/O devices 460 may include liquid crystal displays (LCDs), touch screen displays, keyboards, keypads, switches, dials, mice, track balls, voice recognizers, card readers, paper tape readers, printers, video monitors, or other well-known input devices. Also, the transceiver 425 might be considered to be a component of the I/O devices 460 instead of or in addition to being a component of the network connectivity devices 420.

Various combinations of the components of the system 400, including memory, hardware, firmware, software or others may be referred to herein as a “component”.

In an embodiment a UE is provided. The UE comprising at least one component configured to scan a message content for personal information and indicate any detected personal information before sending the message from the UE.

In another embodiment, a method implemented on a UE is provided. The method comprising scanning a message content for personal information, and indicating any detected personal information before sending the message from the UE.

In another embodiment, a UE is disclosed that includes at least one component configured to scan a message content for personal information using a pattern recognition algorithm that identifies a plurality of patterns that correspond to the personal information, wherein the pattern recognition algorithm is modifiable by a user of the UE to identify certain user patterns related to the user's personal information, the component further configured to indicate any detected personal information before sending the message from the UE and indicate a destination of the message with the detected personal information.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A user equipment (UE), comprising:
at least one component configured to:
scan a message content for personal information using a pattern recognition algorithm that identifies a plurality of patterns that correspond to the personal information, wherein the pattern recognition algorithm is modifiable by a user of the UE to identify certain user patterns related to the user's personal information,
indicate any detected personal information before sending the message from the UE and indicate a destination of the message with the detected personal information.

2. The UE of claim 1, wherein the message content is scanned when a user of the UE requests to send the message from the UE.

3. The UE of claim 1, wherein the message content is scanned in real-time while a user of the UE is typing the message content.

4. The UE of claim 1, wherein the personal information is detected by matching the message content to a list of predefined personal information.

5. The UE of claim 4, wherein the predefined list of personal information is edited by a user of the UE.

6. The UE of claim 1, wherein the personal information comprises one or more of a personal phone number, physical address, and email address.

7. The UE of claim 1, wherein the message is sent using at least one of an instant messaging service, an email service, a web-based service, and Short Message Service (SMS).

8. The UE of claim 1, wherein the detected personal information is stored in a memory or a file in a storage medium.

9. The UE of claim 1, wherein the detected personal information is indicated in a list that is displayed.

10. The UE of claim 1, wherein the detected personal information is highlighted in the message content.

11. The UE of claim 1, wherein the component is further configured to prompt for instruction as to whether to proceed with or abort transmission.

12. The UE of claim 1, wherein the component is further configured to present a plurality of choices including removing the detected personal information from the message content and subsequently transmitting the message.

13. The UE of claim 1, wherein the component is further configured to allow a user to select any detected personal information to be deleted.

14. A method implemented on a user equipment (UE), comprising:
scanning a message content for personal information; and
indicating any detected personal information before sending the message from the UE.

15. The UE of claim 14, wherein the message content is scanned when a user of the UE requests to send the message from the UE.

16. The UE of claim 14, wherein the message content is scanned in real-time while a user of the UE is typing the message content.

17. The UE of claim 14, wherein the personal information is detected using a pattern recognition algorithm that identifies a plurality patterns that correspond to potentially personal information.

18. The UE of claim 17, wherein the pattern recognition algorithm is modified by a user of the UE to identify certain user patterns related to the user's personal information.

19. The UE of claim 14, wherein the personal information is detected by matching the message content to a list of predefined personal information.

20. The UE of claim 19, wherein the predefined list of personal information is edited by a user of the UE.

21. The UE of claim 14, wherein the personal information comprises one or more of a personal phone number, physical address, and email address.

22. The UE of claim 14, wherein the message is sent using at least one of an instant messaging service, an email service, a web-based service, and Short Message Service (SMS).

23. The UE of claim 14, wherein the detected personal information is stored in a memory or a file in a storage medium.

24. The UE of claim 14, wherein the detected personal information is indicated in a list that is displayed.

25. The UE of claim 14, wherein the detected personal information is highlighted in the message content.

26. The UE of claim 14, wherein the method further comprises indicating a destination of the message with the detected personal information.

27. The UE of claim 14, wherein the method further comprises prompting for instruction as to whether to proceed with or abort transmission.

28. The UE of claim 14, wherein the method further comprises presenting a plurality of choices including removing the detected personal information from the message content and subsequently transmitting the message.

29. The UE of claim 14, wherein the method further comprises allowing a user to select any detected personal information to be deleted.
